(19) United States
(12) Patent Application Publication
(10) Pub. No.: US 2026/0074242 A1
(43) Pub. Date: Mar. 12, 2026

(54) INTERNALLY PRESSURIZED ELECTROCHEMICAL CELL STACKS AND METHODS OF OPERATING AND MAKING THEREOF

(71) Applicant: Bloom Energy Corporation, San Jose, CA (US)

(72) Inventors: Dalton COX, Oakland, CA (US); Travis A. SCHMAUSS, Burlingame, CA (US); Matthias GOTTMANN, Sunnyvale, CA (US); Emad EL BATAWI, Aurora, CO (US)

(21) Appl. No.: 19/318,862

(22) Filed: Sep. 4, 2025

Related U.S. Application Data
(60) Provisional application No. 63/692,372, filed on Sep. 9, 2024.

(51) Int. Cl. H01M 8/028; H01M 8/0286; H01M 8/04746; H01M 8/12; H01M 8/1231; H01M 8/242

(52) U.S. Cl. CPC H01M 8/028; H01M 8/0286; H01M 8/04753; H01M 8/1231; H01M 8/242; H01M 2008/1293

(57) ABSTRACT

A method of operating a solid oxide electrolyzer cell stack includes providing steam into a fuel internal riser extending through the solid oxide electrolyzer cell stack at a pressure of at least 15 psig, and electrolyzing the steam in the solid oxide electrolyzer cell stack to generate a hydrogen containing product stream at a pressure of at least 15 psig.

### FIELD

Aspects of the present disclosure relate generally to electrochemical cell stacks, and particularly to internally pressurized electrochemical cell stacks configured to operate using pressurized air and fuel streams.

### BACKGROUND

A typical solid oxide electrochemical cell includes a ceramic electrolyte located between an anode electrode and a cathode electrode. Some stacks are internally manifolded for fuel and include air channels that are open to ambient air.

### SUMMARY

According to various embodiments, an electrochemical cell stack comprises cell units. Each cell unit comprises a first interconnect comprising fuel holes, air holes, and a fuel field that extends between the fuel holes on a fuel side of the first interconnect; a second interconnect comprising fuel holes, air holes, and an air field that extends between the air holes on an air side of the second interconnect; an electrochemical cell comprising a fuel electrode that electrically contacts portions of the fuel field, an air electrode that electrically contacts portions of the air field and a solid oxide electrolyte located between the fuel electrode and the air electrode; a fuel field seal located on the fuel side of the first interconnect and configured to keep the fuel from flowing into the air holes in the first interconnect; ring seals located on the air side of the second interconnect and laterally surrounding the fuel holes; and a pressure seal extending from the fuel side of the first interconnect to the air side of the second interconnect, and laterally surrounding the electrochemical cell, the fuel field seal, and the ring seals.

According to various embodiments, a method of operating a solid oxide electrolyzer cell stack comprises providing steam into a fuel internal riser extending through the solid oxide electrolyzer cell stack at a pressure of at least 15 psig; and electrolyzing the steam in the solid oxide electrolyzer cell stack to generate a hydrogen containing product stream at a pressure of at least 15 psig.

According to various embodiments, a method of forming of an electrochemical cell stack comprises forming a first cell unit by disposing a pressure seal, ring seals, and an electrochemical cell between two vertically stacked interconnects, such that the pressure seal laterally surrounds the ring seals and the electrochemical cell, the ring seals support the weight of the second interconnect, and the electrochemical cells are located between respective air channels and fuel channels of the two vertically stack interconnects; forming additional cell units on the first cell unit to form a stack by disposing, for each additional cell unit, an additional pressure seal, ring seals, an electrochemical cell, and an additional interconnect; sintering the stack to compress the ring seals, such that the interconnects are supported by the pressure seals; applying a compressive load to the stack to compress the pressure seals, such that the interconnects apply a first load to the electrochemical cells; and supplying pressurized air to the air channels and a pressurized fuel to the fuel channels, such that the interconnects apply a second load to the electrochemical cells that is less than the first load.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a perspective view of an electrochemical stack, according to various embodiments of the present disclosure.

FIG. 2A is a cross-sectional view of an anode supported electrochemical cell, and FIG. 2B is a cross-sectional view of an electrolyte supported electrochemical cell, according to various embodiments of the present disclosure.

FIG. 3A is a plan view of the fuel side of an interconnect 200A, according to various embodiments of the present disclosure, FIG. 3B is a plan view of the air side of the interconnect 200A, FIG. 3C is a plan view of a stack cell unit 50A, and FIG. 3D is a partially transparent view showing manifolds of a fuel cell stack 10A including cell unit 50A of FIG. 3C.

FIG. 4A is a plan view of the fuel side of an interconnect 200B, according to various embodiments of the present disclosure, FIG. 4B is a plan view of the air side of the interconnect 200B, FIG. 4C is a partially transparent plan view of a stack cell unit 50B, and FIG. 4D is a partially transparent view showing manifolds of a fuel cell stack 10B including the cell unit 50B of FIG. 4C.

FIG. 5A is a cross-sectional of a unit cell 50B view taken along line L1 of FIG. 4C, and FIG. 5B is a cross-sectional view taken along line L2 of FIG. 4C.

FIGS. 6A-6D are cross-sectional views showing a method of forming an electrochemical cell stack, according to various embodiments of the present disclosure.

FIG. 7A is a plan view of the fuel side of an interconnect 200C, according to various embodiments of the present disclosure, FIG. 7B is a plan view of the air side of the interconnect 200C, and FIG. 7C is a partially transparent plan view of a stack cell unit 50C.

FIG. 8A is a cross-sectional view taken along line L1 of FIG. 7C, and FIG. 8B is a cross-sectional view taken along line L2 of FIG. 7C.

FIG. 9 is a cross-sectional view of an interconnect 200 including alternative sealing features, according to various embodiments of the present disclosure.

FIG. 10 is a perspective, partially see-through view of a modular electrolyzer system according to embodiments of the present invention.

### DETAILED DESCRIPTION

The present disclosure is described more fully herein with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and fully conveys the scope of the invention to those skilled in the art. In the drawings, the size and relative sizes of layers and regions may be exaggerated for clarity. Like reference numerals in the drawings denote like elements.

Electrochemical cell systems include fuel cell and electrolyzer cell systems. In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can include a hydrogen containing fuel, such as hydrogen (H₂), ammonia or a hydrocarbon fuel, such as methane, natural gas, pentane, ethanol, and/or methanol. The fuel cell, operating at a typical temperature between 650° C. and 850° C., enables the transport of negatively charged oxygen ions from the cathode flow stream to the anode flow stream, where the oxygen ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit. In an electrolyzer system, such as a solid oxide electrolyzer system, the fuel typically comprises water (e.g., steam) that is separated into hydrogen and oxygen by applying a voltage across the electrolyzer cells.

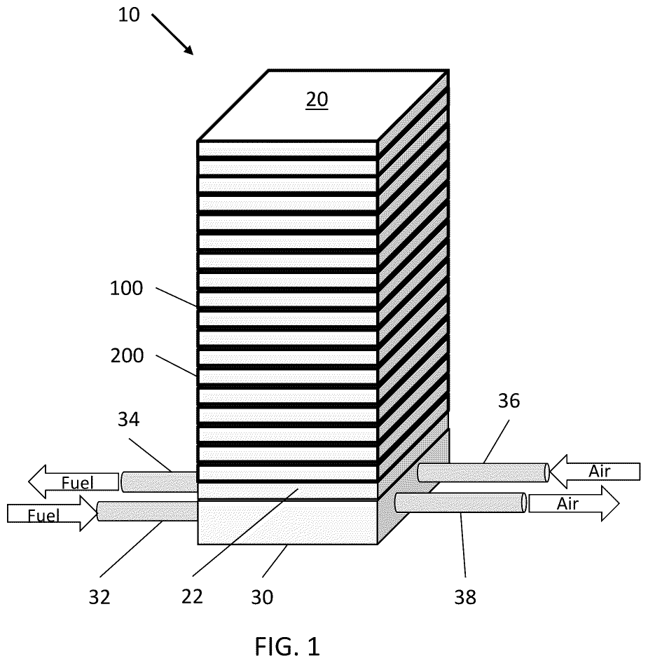

FIG. 1 is a perspective view of an electrochemical cell stack 10, according to various embodiments of the present disclosure. In the embodiments below, the stack 10 is described as being operated as a solid oxide fuel cell (SOFC) stack 10. However, it should be noted that the stack 10 may also be operated as an electrolyzer (e.g., a solid oxide electrolyzer cell (SOEC) stack). Referring to FIG. 1, the stack 10 includes electrochemical cells 100, such as fuel cells (e.g., SOFCs) or electrolyzer cells (e.g., SOECs), separated by interconnects 200. The stack 10 also includes a top plate 20, an opposing bottom plate 22. In some embodiments, the top plate 20 and the bottom plate 22 may be modified interconnects that lack one of fuel channels or air channels.

The interconnects 200 electrically connect adjacent cells 100 in the stack 10. In particular, an interconnect 200 may electrically connect the fuel electrode of one cell 100 to the air electrode of an adjacent cell 100. An optional Ni mesh or another three dimensional compliant conductive structure may be used to electrically connect the interconnects 200 to the fuel electrodes of the electrochemical cells 100.

Each interconnect 200 may be made of or may contain electrically conductive material, such as a metal alloy (e.g., chromium-iron alloy) which has a similar coefficient of thermal expansion to that of the solid oxide electrolyte in electrolyte supported cells (e.g., a difference of 0-10%). For example, the interconnects 200 may each include a metallic substrate comprising a high-temperature stable metal alloy, such as a chromium-iron alloy, such as 4-6 weight percent iron, optionally 1 or less weight percent yttrium and balance chromium alloy and may electrically connect the fuel electrode of one fuel cell 100 to the air electrode of an adjacent fuel cell 100. In other embodiments, the interconnects 200 may be formed of a stainless steel material, such as a ferritic stainless steel, such as SS 430 steel containing 16 to 18 wt. % Cr, below 0.12 wt. % C, between 0 and 0.75 wt. % Ni, between 0 and 1 wt. % Si and/or Mn each, and balance iron with various impurities (e.g., unavoidable impurities, e.g., 0 to less than 0.1 wt. % Mo), or VDM® Crofer 22 APU alloy which contains 20 to 24 wt. % Cr, 0.3 to 0.8 wt. % Mn, 0.04 to 0.2 wt. % La, 0.03 to 0.2 wt. % Ti and balance iron and various impurities (e.g., unavoidable impurities). Thus, the interconnect 200 may comprise a ferritic stainless steel interconnect containing at least 15 wt. % Cr and at least 50 wt. % Fe, such as 16 to 24 wt. % Cr and 76 to 84 wt. % Fe. The interconnects 200 may be formed by any suitable method, such as by powder metallurgy, coining, sheet metal forming, stamping, casting, 3D printing, or the like. The steel interconnects may have a similar coefficient of thermal expansion to that of the solid oxide fuel electrode in the cells (e.g., a difference of 0-10%) for fuel electrode supported cells.

An electrically conductive contact layer, such as a nickel layer or mesh, may be provided between fuel sides of the cells 100 and each interconnect 200. An electrically conductive protective layer, such as metal oxide layer, for example lanthanum strontium manganate and/or manganese cobalt spinel, may be provided on at least an air side of each interconnect 200.

The stack 10 may be located on a stack manifold 30 configured to provide a fuel (e.g., a hydrogen, ammonia or hydrocarbon fuel, steam, carbon dioxide, carbon monoxide, etc.) and an oxidant (e.g., air) to the stack 10 at a pressure above atmospheric pressure. In particular, the stack manifold 30 may be configured to provide pressurized fuel and air inlet streams to the stack 10 and receive pressurized fuel exhaust and air exhaust streams from the stack 10. As such pressurized fuel and air may be circulated within the stack 10 and among the electrochemical cells 100.

For example, in a SOFC stack configuration, the stack manifold 30 may provide a pressurized fuel, such as a hydrocarbon fuel (e.g., natural gas, methane, etc.), hydrogen (H₂), or ammonia to the stack 10 via a fuel inlet conduits 32, and may receive fuel exhaust (e.g., product stream) from the stack 10 via a fuel outlet conduit 34. The stack manifold 30 may also provide pressurized air to the stack 10 and receive air exhaust from the stack 10 via respective air (e.g., oxidant) inlet and outlet conduits 36, 38. In an SOEC stack configuration, the stack manifold 30 may provide pressurized steam and optionally carbon dioxide to the stack 10 and may receive hydrogen and carbon monoxide from the stack 10.

In some embodiments, the stack manifold 30 may be configured to provide pressurized fuel and air to the stack 10, to generate an internal stack pressure of at least 15 psig. For example, the internal stack pressure may be greater than 1.2 bar, such as 1.5 to 30 bar, including 1.75 to 2.25 bar (e.g., greater than 0.2 bar gauge (barg), such as 0.5 to 29 barg including 0.75 to 1.25 barg).

In SOEC applications, the stack manifold may be configured to generate an internal stack pressure ranging from about 3 bar to about 50 bar, such as from about 5 bar to about 20 bar. For example, the stack 10 may be utilized to electrolyze a fuel inlet stream comprising both CO₂ and H₂O (i.e., steam) to generate synthetic natural gas (e.g., methane) product (i.e., fuel exhaust) stream directly from the stack 10, at an internal stack pressure ranging from about 5 bar to about 15 bar.

Electrochemical cells 100, such as SOFCs and SOECs, are typically supported to increase mechanical stability and reliability. For example, supported cells include electrode-supported cells, electrolyte-supported cells, and co-supported cells. Electrolyte-supported cells include a relatively thick electrolyte upon which relatively thin electrodes are formed. Electrode supported cells include a relatively thick supporting electrode (e.g., the fuel electrode, such as the anode in SOFC or the cathode in SOEC) to provide structural support, and co-supported cells may include a relatively thick supporting electrode and a relatively thick electrolyte.

Electrolyte-supported cells offer numerous advantages including improved sealing resulting from a dense electrolyte perimeter and reduction stability due to having a thin fuel electrode. However, electrolyte-supported cells often exhibit higher area specific resistance (e.g., Ohmic resistance) values than electrode-supported cells because the electrolyte typically exhibits lower conductivity than the anode or cathode materials. For example, in electrolyte-supported solid oxide fuel cells, the ohmic resistance of the electrolyte may be the largest contributor to the total area specific resistance of the cell at typical operating temperatures (e.g., at about 800 to 850° C.).

Electrode-supported SOFCs and SOECs are typically produced by co-sintering a support electrode material and a coating of electrolyte material. Electrode-supported fuel cells include anode-supported cells having a relatively thick anode and cathode-supported cells having a relatively thick cathode. Cathode-supported fuel cells have the potential to be lightweight and lower in cost than anode-supported cells. However, processing of cathode-supported cells is difficult because the co-firing of most cathode materials in contact with an electrolyte produces insulating intermediate compounds.

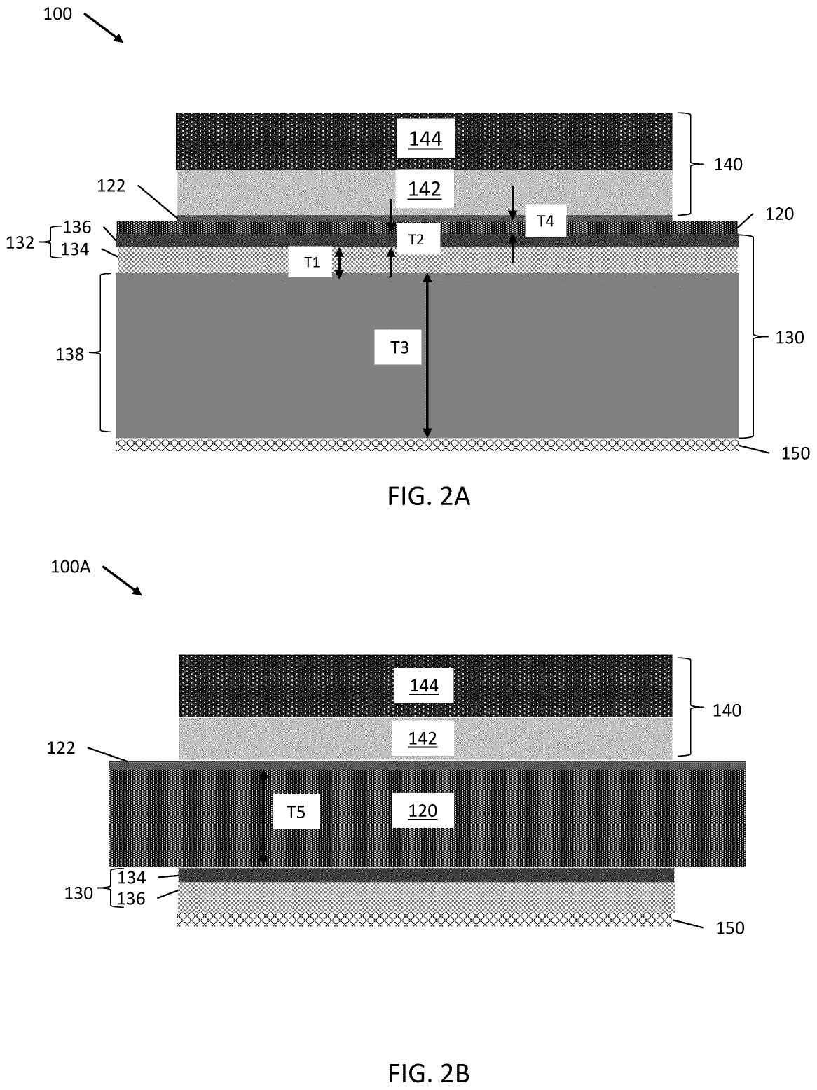

FIG. 2A is a cross-sectional view of an electrode-supported electrochemical cell 100, and FIG. 2B is a cross-sectional view of an electrolyte-supported electrochemical cell 100A, according to various embodiments of the present disclosure.

Referring to FIGS. 2A and 2B, the electrochemical cells 100, 100A may include an electrolyte 120, a fuel electrode 130 (e.g., SOFC anode or SOEC cathode) located on a first side (e.g., fuel side) of the electrolyte 120, and an air electrode 140 (e.g., SOFC cathode or SOEC anode) located on a second side (e.g., air side) of the electrolyte 120. The electrolyte 120 may be formed of an ionically conductive ceramic material, such as a doped zirconia material or a doped ceria material. For example, the electrolyte 120 may include scandia stabilized zirconia (SSZ), yttria stabilized zirconia (YSZ), yttria-ceria-stabilized zirconia (YCSZ), ytterbia-ceria-scandia-stabilized zirconia (YbCSSZ), or blends thereof.

Preferably, the electrolyte may include YbCSSZ, wherein scandia may be present in an amount equal to 9 to 11 mol %, such as 10 mol %, ceria may present in amount greater than 0 and equal to or less than 3 mol %, for example 0.5 mol % to 2.5 mol %, such as 1 mol 9%, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference.

The electrolyte 120 may optionally include a barrier layer 122 located on the air side. The barrier layer 122 may be configured to prevent diffusion of air electrode 140 materials into the electrolyte 120.

The air electrode 140 may be located on the barrier layer 122. The air electrode 140 may be a single or multi-layer structure. For example, the air electrode 140 may include a functional layer 142 and a contact layer 144. The functional layer 142 may include a catalyst, such as lanthanum strontium manganate, lanthanum strontium cobaltite, lanthanum strontium cobalt ferrite or lanthanum nickel ferrite. The contact layer 144 may include an electrically conductive material, such as lanthanum strontium manganate configured to reduce electrical resistance between the air electrode 140 and an adjacent component, such as an interconnect.

The fuel electrode 130 may include an active layer 132 located on the fuel side of the electrolyte 120 and a support 138 located on the active layer 132. The active layer 132 may include a nickel containing phase and an ionically conductive ceramic phase, such as SSZ, YSZ, YbCSSZ, or a doped ceria such as gadolinia, yttria and/or samaria doped ceria, such as samaria-doped ceria (SDC). Preferably, the active layer 132 comprises a Ni-SDC cermet or a Ni—YbCSSZ cermet. In some embodiments, the Ni phase may include additional dopants to improve phase stability and/or redox tolerance.

The active layer 132 may be a single or multi-layer structure. For example, the active layer 132 may include a first functionally graded anode (FGA) layer 134 and a second FGA layer 136. The first FGA layer 134 may include a lower ratio of the nickel containing phase to the ionically conductive phase than the second FGA layer 136. While the term FGA refers to an “anode” it should be understood that the active layer 132 may function as a cathode in the SOEC.

The first FGA layer 134 may have a thickness T1 ranging from about 7 μm to about 17 μm, such as from about 10 μm to about 14 μm, or from about 11 μm to about 13 μm. The second FGA layer 136 may have a thickness T2 ranging from about 2 μm to about 10 μm, such as from about 4 μm to about 8 μm, or from about 5 μm to about 6 μm. However, the present disclosure is not limited to any particular FGA layer thicknesses.

The support 138 may be formed of a cermet material having a metal phase and a ceramic phase. For example, the support 138 may include a nickel-containing phase (e.g., nickel phase) and a ceramic phase. The nickel phase may include nickel and/or nickel alloys and may optionally include other additional metal dopants to improve phase stability and/or redox tolerance. A compliant contact layer 150, such as a nickel mesh, may be located below the fuel electrode 130.

The ceramic phase may comprise a stabilized zirconia, yttria stabilized zirconia (YSZ), scandia stabilized zirconia (SSZ), yttria-scandia stabilized zirconia (YSSZ), and/or a doped ceria material, such as gadolinia, yttria and/or samaria doped ceria. The ceramic phase may be optionally doped with additional phase stabilizers, as discussed in detail below. Preferably, the ceramic phase of the support 138 comprises YSZ comprising from about 3 mol % to about 10 mol % yttria (3-10)-YSZ. The ceramic phase (e.g., the (3-10)-YSZ) may include additional dopants (e.g., phase stabilizers) to improve phase stability.

As shown in FIG. 2A, in the electrode-supported electrochemical cell 100 (e.g., fuel electrode supported electrochemical cell 100, such as the anode-supported fuel cell 100) the support 138 may have a thickness T3 ranging from about 200 μm to about 600 μm, such as from about 300 μm to about 500 μm, from about 350 μm to about 450 μm, or about 400 μm. The electrolyte 120 may have a thickness T4 ranging from about 5 μm to about 15 μm, such as from about 8 μm to about 12 μm, or from about 10 μm. Accordingly, the relatively thick support 138 may support the relatively thin electrolyte 120.

As shown in FIG. 2B, the electrolyte-supported electrochemical cell 100A may include a relatively thick electrolyte 120. In particular, electrolyte 120 may have a thickness T5 ranging from about 50 μm to about 200 μm, such as from about 75 μm to about 125 μm, from about 85 μm to about 115 μm, or about 100 μm. The relatively thick electrolyte 120 may be self-supporting.

Operating SOEC and SOFC cell stacks 10 at above atmospheric pressure may provide a number of benefits. Electrolyte supported cells benefit from the elimination or reduction of Knudsen diffusion from constrictive pores in the support when the cells operate above atmospheric pressure. Furthermore, a prior study (S. H. Jensen, et. al., Journal of The Electrochemical Society, 163 (14) F1596-F1604 (2016)) has shown that reaction kinetics of both SOEC and SOFC reactions are increased when SOEC and SOFC cell stacks are operated at above atmospheric pressure in a separate pressure vessel housing the stacks. The pressure vessel was pressurized above atmospheric pressure, thus pressurizing cell stacks located inside the pressure vessel. SOFC operation benefited both from increased open circuit voltage (OCV) and enhanced kinetics to increase the power density. SOEC operation was hindered by the increased OCV, but the enhanced kinetics produced superior performance at the thermoneutral voltage (˜1.3 V/cell) for all pressures compared to operation at 1 bar pressure.

The hydrogen (H₂) product generated by an SOEC system is generally compressed for storage and/or to satisfy requirements of various systems that operate using the generated hydrogen. While this compression can be achieved using a hydrogen compressor fluidly connected to an outlet of the stack, electrochemical hydrogen compressors are expensive and are generally based on polymer membrane technology with lower maximum operating temperatures, requiring additional system components to cool the product stream before it reaches the hydrogen compressor. Even if the hydrogen compressor is added to the SOEC system, it may benefit from a higher than atmospheric pressure inlet feed provided from a SOEC stack operating at above atmospheric pressure.

For example, a hydrogen product outlet pressure of about 7 bar (100 psi) allows for improved integration of the SOEC system into the Haber-Bosch process system in which the SOEC stack 10 generated hydrogen product is utilized to generate ammonia. Synthetic fuel applications fed by electrolysis or co-electrolysis also benefit from pressurization of the outgoing product gas streams, with typical operating pressures for hydrogen product ranging from 10-900 bar, for methane product ranging from 20-50 bar, and for methanol product ranging from 50-140 bar. Pressurization, especially at low temperatures, may beneficially allow for synthetic natural gas (SNG) (e.g., methane) production directly within the SOEC stack by co-electrolysis of a CO₂ and H₂O (e.g., steam) fuel inlet stream mixture.

According to various embodiments, power and electrolyzer systems may include multiple SOFC or SOEC stacks located in an insulated hotbox, along with other system components, in order to maintain stack operating temperatures. Hotboxes are not hermetically sealed and do not function as pressure vessels. In prior art systems, cell stacks are pressurized by disposing the hotbox in a pressure vessel, or by including individual pressure vessels for each of the stacks in the hotbox. However, such solutions are costly and/or often are impractical due to system and/or hotbox space constraints. In addition, the ceramic components of the cells are sensitive and may be prone to fracture if fuel and air pressures are not balanced in the pressure vessel.

Accordingly, embodiments of the present disclosure provide solid oxide cell stacks (e.g., SOEC and/or SOFC stacks) that are designed to operate using a pressurized fuel stream 15 psig or above without requiring an external pressure vessel. In other words, the embodiment solid oxide cell stacks are configured to operate at internal stack pressures in excess of atmospheric pressure.

In one embodiment, air may also be provided into an air internal riser extending through the solid oxide electrolyzer cell stack at a pressure of at least 15 psig. In an alternative embodiment, external air is either not supplied through the solid oxide electrolyzer cell stack or is supplied at atmospheric pressure. If the air is not supplied to the stack, then oxygen may evolve at the air electrode until it reaches 15 psig. A relief valve on the air side may be used to keep the pressure constant. In this embodiment, the stack would operate at higher voltages with less efficiency. However, an air compressor or air blower which provides external air to the stack may be omitted in this embodiment.

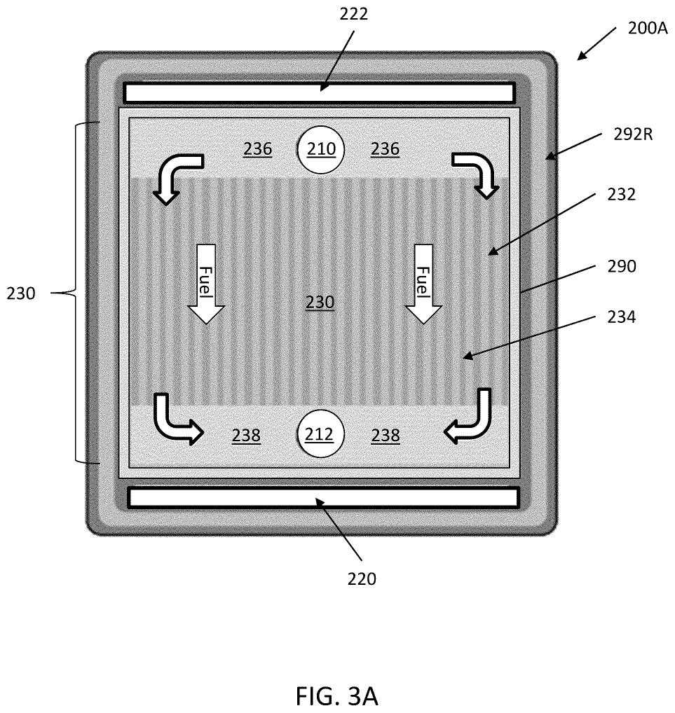

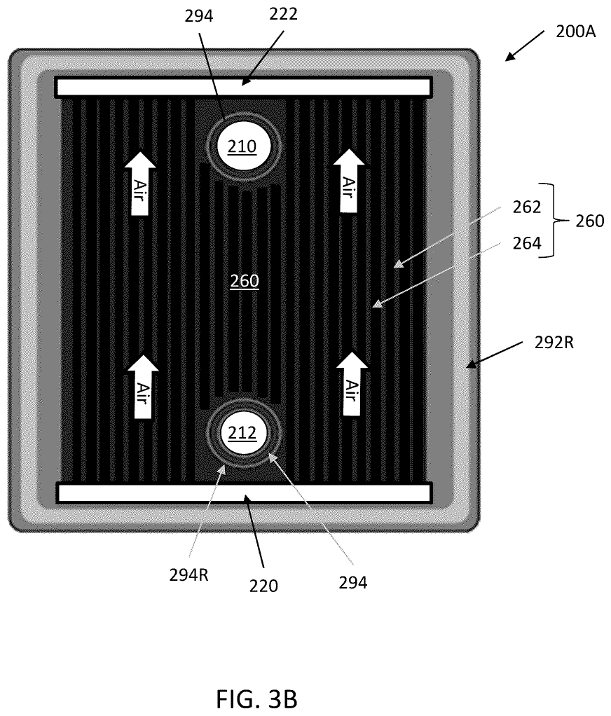

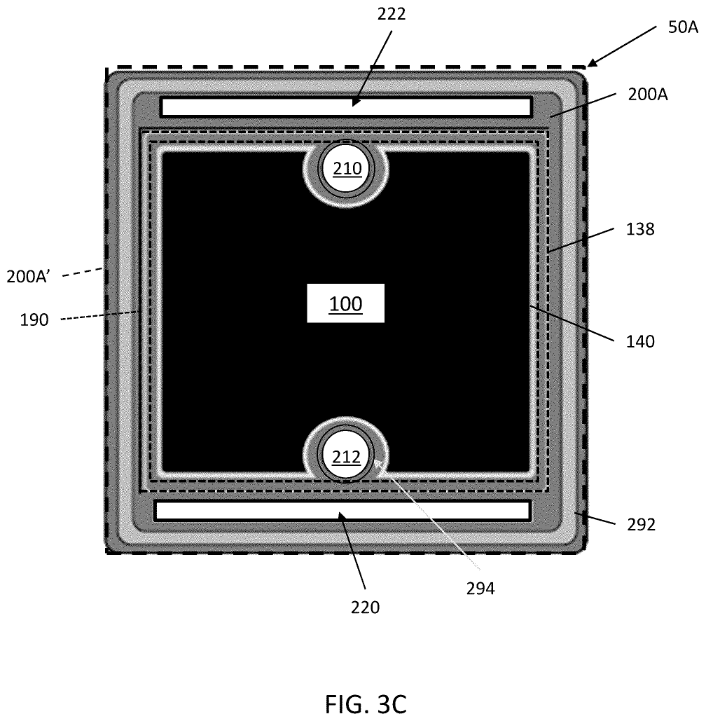

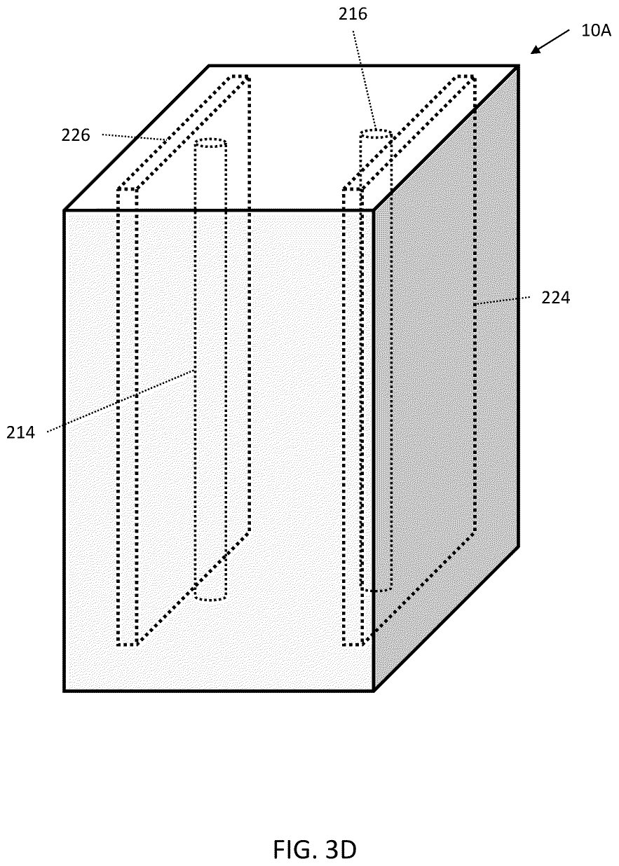

FIG. 3A is a plan view of the fuel side of an interconnect 200A, according to various embodiments of the present disclosure, FIG. 3B is a plan view of the air side of the interconnect 200A, FIG. 3C is a plan view of a stack cell unit 50A, and FIG. 3D is a partially transparent view showing manifolds of a fuel cell stack 10A including the cell unit 50A of FIG. 3C. Referring to FIG. 3A, the interconnect 200A may include fuel holes 210, 212 and air holes 220, 222 that extend through the interconnect 200A in a thickness direction.

A fuel field 230 may be formed on the fuel side of the interconnect 200A and may extend between the fuel holes 210, 212. The fuel holes 210, 212 may be located between and/or laterally inward from the air holes 220, 222. In other words, the fuel and air holes 210, 222 may be located adjacent to a first edge of the interconnect 200A, and the fuel and air holes 212, 220 may be located adjacent to an opposing second edge of the interconnect 200A.

The fuel field 230 may include fuel channels 232, fuel ribs 234 that separate and define sidewalls of the fuel channels 232, an inlet manifold 236, and an outlet manifold 238. Surfaces of the inlet and outlet manifolds 236, 238 may be recessed below tops of the fuel ribs 234.

When the interconnect 200A is located in a cell stack 10A, a fuel (e.g., a hydrogen, ammonia or hydrocarbon fuel, steam, etc.) flows through the fuel hole (e.g., inlet fuel hole) 210 and into the inlet manifold 236. The inlet manifold 236 distributes the fuel such that the fuel enters first ends of the fuel channels 232. The fuel flows through the fuel channels 232 and then exits opposing second ends of the fuel channels 232 and enters the outlet manifold 238. The fuel flows from the outlet manifold 238 and then into the fuel hole (e.g., outlet fuel hole) 212. Accordingly, the fuel hole 210 may operate as a fuel inlet, and the fuel hole 212 may operate as a fuel exhaust outlet (e.g., a product outlet in a SOEC stack 10A).

As discussed in more detail below, fuel field seal (e.g., “window” seal) 290 may surround the fuel field 230 and may be located on a corresponding seal region of the interconnect 200A. The fuel field seal 290 may be configured to seal the fuel side of the interconnect 200A to the fuel side of an electrochemical cell located thereon. As such, the fuel field seal 290 is configured to prevent the fuel from exiting the fuel field 230 and flowing towards the edges of the interconnect 200A (i.e., flowing out of the fuel field 230 in a direction parallel to a plane of the fuel side of the interconnect 200A). The air holes 220 and 222 are located outside the perimeter of the fuel field seal 290. The interconnect 200A may include a recessed pressure seal region 292R that surrounds the fuel field 230 and the air holes 220, 222. In particular, the pressure seal region 292R may be around adjacent to the peripheral edges of the interconnect 200A. The air holes 220 and 222 are located inside the perimeter of the pressure seal region 292R (i.e., between the pressure seal region 292R and the fuel field seal 290).

Referring to FIG. 3B, the air side of the interconnect 200A may include an air field 260 extending between the air holes 220, 222 and comprising air channels 262 and air ribs 264 located between and defining the sidewalls of the air channels 262. Ring seals 294 may be located on planar ring seal regions 294R that surround the fuel holes 210, 212.

When the interconnect 200A is incorporated in a cell stack 10A, the air inlet stream provided from the air hole (e.g., inlet air hole) 220 may flow through the air channels 262 to the air hole (e.g., outlet air hole) 222. Accordingly, the air hole 220 may operate as an air inlet, and the air hole 222 may operate as an air and/or air exhaust outlet. As such, the fuel and the air may flow in opposite directions across the air and fuel sides of the interconnect 200A, such that the interconnect 200A has a counter flow configuration. Alternatively, the fuel and air may flow in the same direction across the air and fuel sides of the interconnect 200A, such that the interconnect 200A has a co-flow configuration.

The air field 260 may be exposed to oxygen at high temperatures when utilized in a solid oxide cell stack. As such, an electrically conductive protective layer may be formed on the air field 260 to protect the air field 260 from corrosion and/or oxidation. The protective layer may comprise a metal oxide coating applied by an atmospheric plasma spray (APS) process or a physical vapor deposition process. In some embodiments, the protective layer may comprise a lanthanum strontium manganate and/or manganese cobalt spinel material.

Referring to FIGS. 2A and 3A-3C, the cell unit 50A may include an electrode-supported cell (e.g., SOEC or SOFC) 100 located between two interconnects 200A, 200A′. In particular, the cell 100 may be located on the fuel side of the interconnect 200A, such that the fuel electrode 130 faces the fuel field 230 and electrically contacts portions of the ribs 234 (e.g., directly contacts or indirectly contacts via a conductive contact layer). The fuel field seal 290 contacts the perimeter of the fuel electrode 130 and the interconnect 200A to seal the fuel side of the cell 100. As such, the fuel field seal 290 is configured to prevent the fuel from leaking out of the fuel field 230 and flowing towards peripheral edges of the interconnect 200A. In other words, the fuel field seal 290 may prevent mixing of fuel and air.

The air side ribs 264 of the interconnect 200A′ may contact the air electrode 140 of the cell 100. The pressure seal 292 may be located on or in the pressure seal regions 292R of the interconnects 200A, 200A′, to seal the interconnects 200A, 200A′ together. In particular, the pressure seal 292 may be configured to prevent air from flowing past the perimeters of the interconnects 200A, 200A′. Thus, the pressure seal 292 surrounds the periphery of each interconnect 200A, 200A′.

Referring to FIG. 3D, the cell unit 50A of FIG. 3C may be assembled into a cell stack 10A. The alignment of the fuel holes 210, 212 may respectively form a fuel inlet manifold (e.g., riser opening) 214 and a fuel outlet manifold (e.g., riser opening) 216. Similarly, the alignment of the air holes 220, 222 may form an air inlet manifold (e.g., riser opening) 224 and an air outlet manifold (e.g., riser opening) 226.

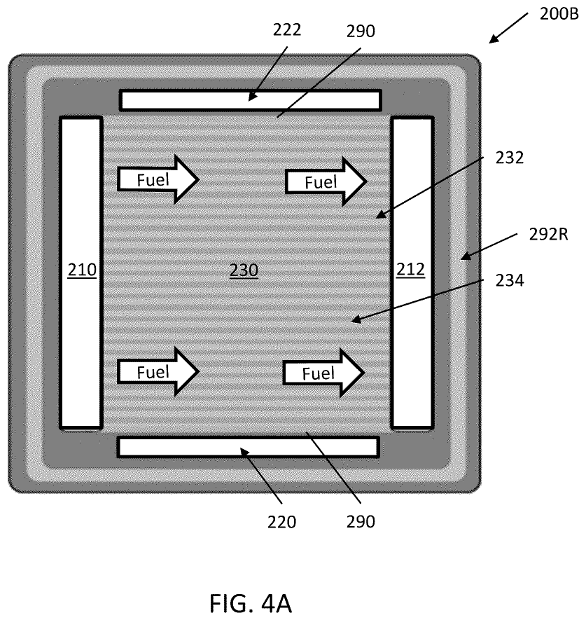

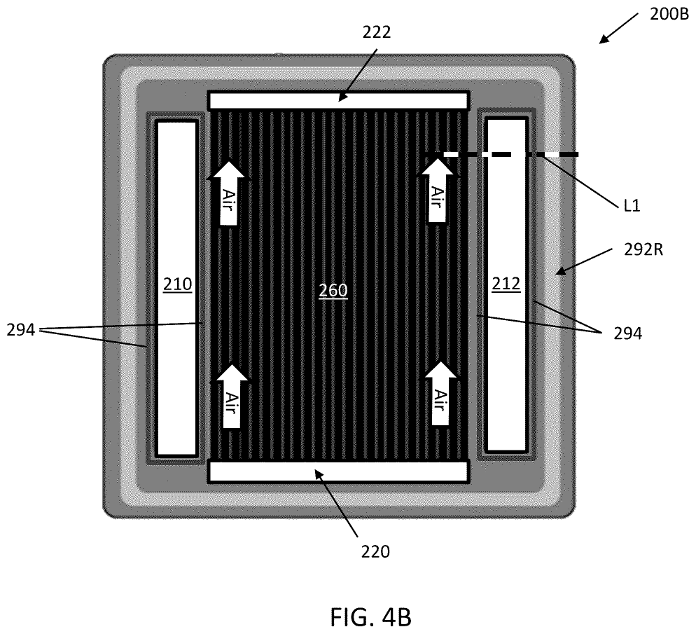

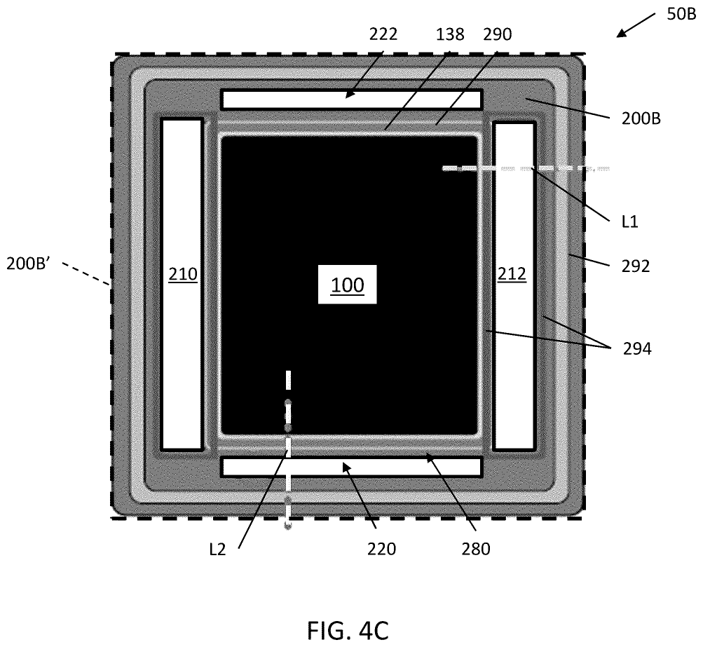

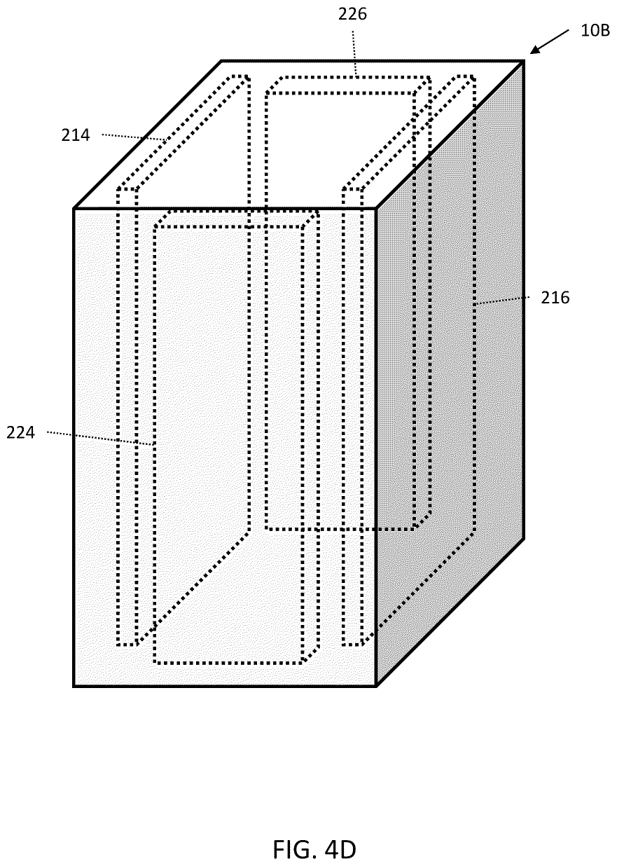

FIG. 4A is a plan view of the fuel side of an interconnect 200B, according to various embodiments of the present disclosure, FIG. 4B is a plan view of the air side of the interconnect 200B, FIG. 4C is a partially transparent plan view of a stack cell unit 50B, and FIG. 4D is a partially transparent view showing manifolds of a fuel cell stack 10B including the cell unit 50B of FIG. 4C. The interconnect 200B may be similar to the interconnect 200A. As such, only the differences therebetween will be discussed in detail. In one embodiment, the interconnect 200B may be formed from stainless steel.

Referring to FIGS. 4A and 4B, the interconnect 200B may include fuel holes 210, 212 and air holes 220, 222. The fuel holes 210, 212 may be located adjacent to opposing first and second edges of the interconnect 200B. The air holes 220, 222 may be located adjacent to opposing third and fourth edges of the interconnect 200B.

As shown in FIG. 4A, the fuel side of the interconnect 200B may include a fuel field 230 located between the fuel holes 210, 212. Strip-shaped fuel field seals 290 may be located between opposing sides of the fuel field 230 and the air holes 220, 222.

As shown in FIG. 4B, the air side of the interconnect 200B may include an air field 260 located between the air holes 220, 222. Ring seals 294 are located around the fuel holes 210, 212.

Fuel may flow across the fuel field 230 in a first direction, and air may flow across the air field 260 in a second direction perpendicular to the first direction. Accordingly, the interconnect 200B may have a cross flow configuration. Both sides of the interconnect 200B may include recessed pressure seal regions 292R that surround the fuel and air holes 210, 212, 220, 222.

Referring to FIG. 4C, the cell unit 50B may include an electrode-supported cell 100 located between two interconnects 200B, 200B′. The fuel electrode 130 of the electrochemical cell 100 may be located on the fuel side of the interconnect 200B. Ring seals 294 are located around the fuel holes 210, 212 and may overlap with the fuel electrode 130 of the cell 100. A pressure seal 292 may be located on the pressure seal region 292R, and a second interconnect 200B′ may be located over the cell 100.

Referring to FIG. 4D, the cell unit 50B of FIG. 3C may be assembled into a cell stack 10B. The alignment of the fuel holes 210, 212 may respectively form a fuel inlet manifold (e.g., riser opening) 214 and a fuel outlet manifold (e.g., riser opening) 216. Similarly, the alignment of the air holes 220, 222 may form an air inlet manifold (e.g., riser opening) 224 and an air outlet manifold (e.g., riser opening) 226.

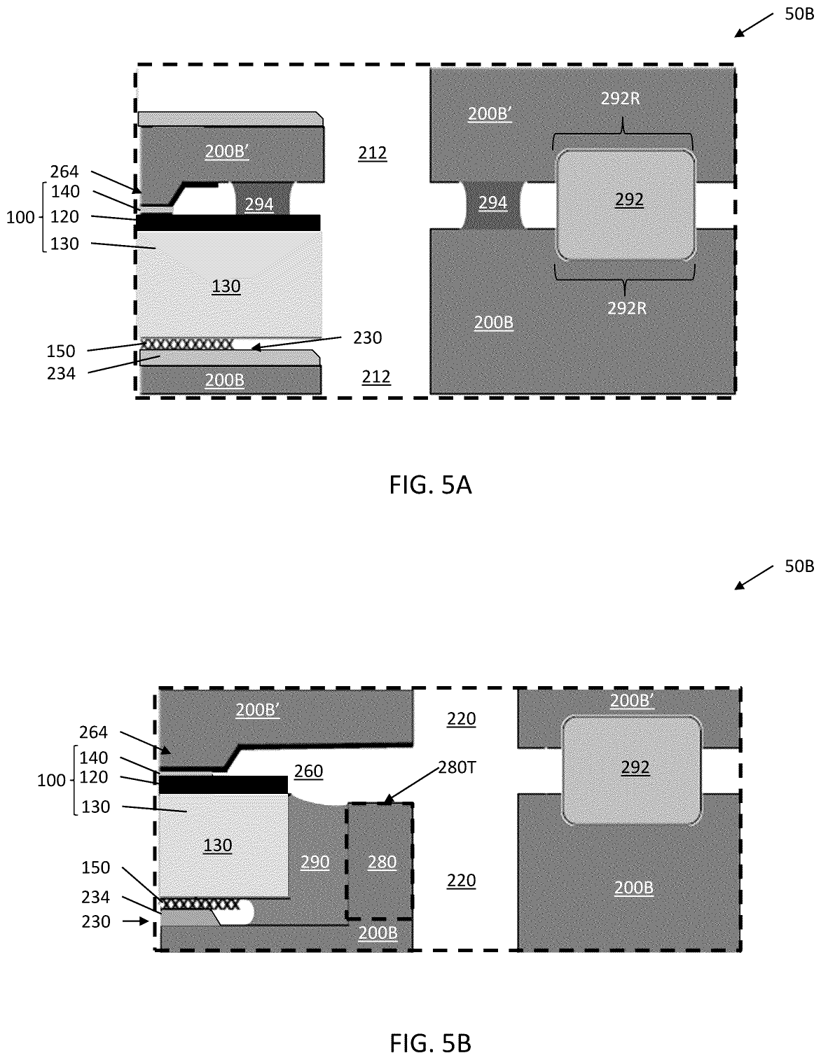

FIG. 5A is a cross-sectional view of a stack cell unit 50B taken along line L1 of FIGS. 4B and 4C, and FIG. 5B is a cross-sectional view taken along line L2 of FIG. 4C. Referring to FIG. 5A, a first portion of the ring seal 294 that surrounds the fuel holes 212 and overlaps the edge of the fuel electrode 130 may contact the second interconnect 200B′ and the fuel electrode 130 of the cell 100, and a second portion of the ring seal 294 that does not overlap the fuel electrode 130 may contact opposing surfaces of the interconnects 200B, 200B′. The pressure seal 292 may be located in recessed pressure seal regions 292R formed in opposing surfaces of the interconnects 200B, 200B′. The air side ribs 264 of the interconnect 200B′ may contact the air electrode 140 of the cell 100. The compliant contact layer 150 may be located between the fuel ribs 234 of the interconnect 200B and the fuel electrode 130 of the cell 100.

Referring to FIG. 5B, the fuel field 230 may be recessed with respect to at least a portion of the top surface 280T of the fuel side of the interconnect 200B. For example, support walls 280 may be located on opposing sides of the fuel field 230, between the fuel field 230 and the air holes 220, 222. As such, the cell 100 may be “nested” within a recess in the interconnect 200B. The fuel field seal 290 may be in the form of linear segments located between the support walls 280 and the fuel electrode 130 and may also be located under the fuel electrode 130. In various embodiments, the fuel field seal 290 may be reflowed during stack sintering such that the fuel field seal 290 flows under the edges of cell 100 and seals the space between the cell 100 and the interconnect 200B adjacent to the air holes 220, 222. As such, the fuel field seals 290 prevent mixing of fuel and air.

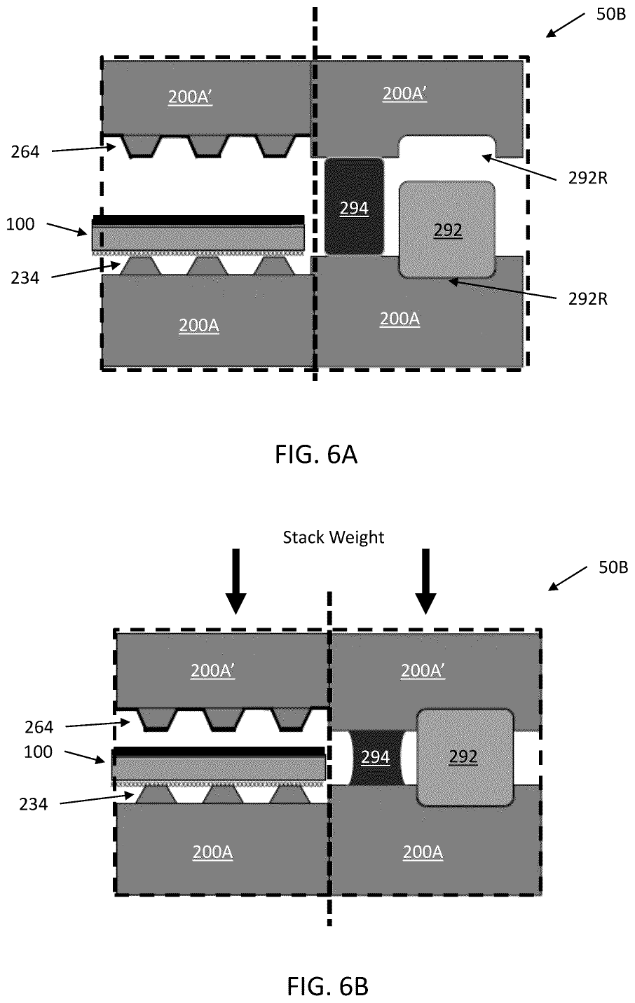

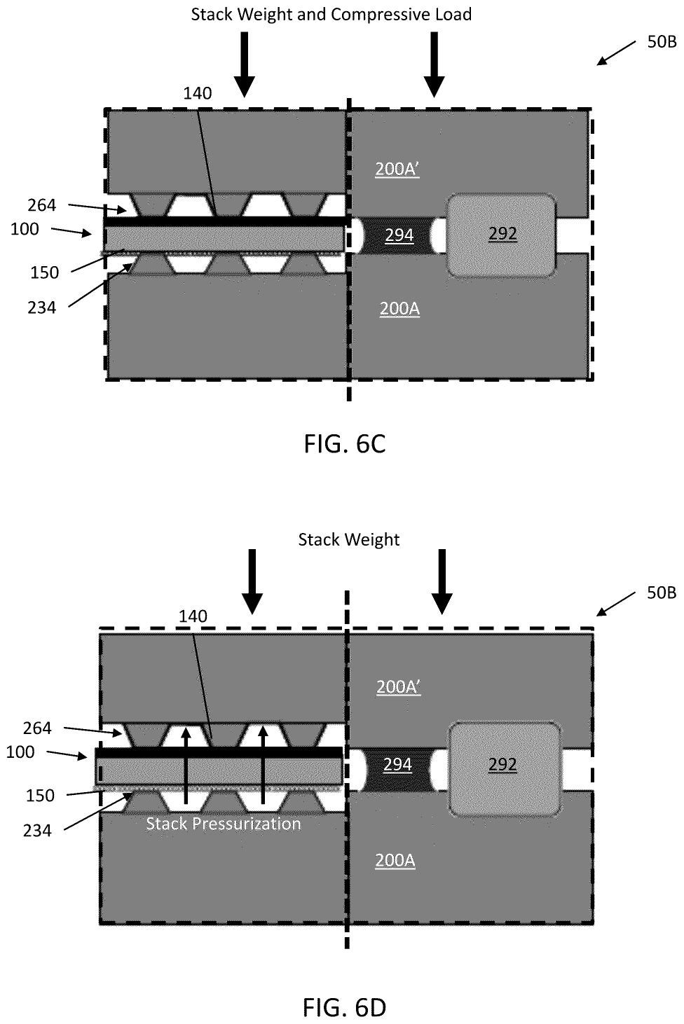

FIGS. 6A-6D are cross-sectional views of a method of forming an electrochemical cell stack, according to various embodiments of the present disclosure. Referring to FIG. 6A, a pressure seal 292 and ring seals 294 may be located on a fuel side of a first interconnect 200A. In particular, the pressure seal 292 may be located in a recessed seal region 292R of the first interconnect 200A and the ring seals 294 may be located inward of the pressure seal 292, surrounding fuel holes (not shown). A compliant contact layer 150 and a cell 100 may be located on the fuel side of a first interconnect 200A, such that the compliant contact layer 150 contacts portions of the fuel side ribs 234 of the interconnect 200A. A fuel field seal 290 (not shown) may be deposited around the cell 100. The ring seals 294 and the fuel field seal 290 may be deposited as a paste including a glass or glass-ceramic material powder and a binder.

A second interconnect 200A′ may be located over the first interconnect 200A to form a cell unit, such that the air side of the second interconnect 200A′ faces the cell 100.

The as-deposited thickness of the ring seals 294 may be greater than the as-deposited thickness of the pressure seal 292. The second interconnect 200A′ is supported by the ring seals 294, and no pressure is applied to the cell 100. Additional cells 100 and interconnects may be stacked on top of the cell unit to form a cell stack or column comprising multiple cell units.

Referring to FIG. 6B, the stack is heated to a temperature above 300 degrees Celsius, such as 350 to 900 degrees Celsius, such that the binder included in the ring seals 294 burns off. If the temperature is sufficiently high, the ring seals 294 may also reflow. As a result, the thickness of the ring seals 294 is reduced, and the weight of the stack compresses the interconnects 200A, 200A′ until the second interconnect 200A′ is supported by the pressure seal 292.

As shown in FIG. 6C, a load may then be applied to the stack while the stack is sintered, to compress the pressure seal 292. For example, the pressure seal 292 may have an initial thickness ranging from about 0.25 mm to about 1 mm, such as from about 0.5 mm to about 0.75 mm. When a load of about 1 Mpa is applied to the stack, the pressure seal 292 may be compressed by about 20 μm. When a load of about 2 Mpa is applied to the stack, the pressure seal 292 may be compressed by a total distance of about 32 μm and the ribs 264 may contact portions of the cell 100. At a pressure of about 3 Mpa, the pressure seal 292 may be compressed by a total distance of about 38 μm. The compliant contact layer 150 may be compressed to alleviate some of the pressure applied to the cell 100, such that a total force applied to the cell 100 is less than about 450 lbf.

As shown in FIG. 6D, pressurized air and fuel streams may be provided to the stack to internally pressurize the stack. For example, the stack may be pressurized to above 1 bar, such as about 15 psig. The application of pressurized air and fuel to both sides of the cell 100 may reduce the pressure applied to the pressure seal 292 to about 2 MPa. As such, the interconnects 200A, 200A′ may separate from one another by about 6 μm due to the internal pressurization of the stack. Since the air and fuel pressures are balanced, the risk of fuel leakage from the stack and/or cell damage is significantly reduced, as compared to prior art external stack pressurization methods using an external pressure vessels.

As shown in FIGS. 5A-6D, the seals 290, 292, 294 are located in different locations, are subjected to different forces, and serve different functions. Accordingly, seal materials for each of the seals 290, 292, 294 may be selected based on corresponding seal properties.

For example, the fuel pressure applied inside of the fuel field seal 290 is balanced by the air pressure applied outside of the fuel field seal 290, resulting in no net lateral pressure applied to the fuel field seal. In addition, little to no voltage is applied across the fuel field seal 290 if the cell comprises an electrode supported cell. Thus, fuel field seal 290 may preferably have a relatively high flowability, in order to seal the fuel electrode 130 and form an appropriate meniscus at its top surface, as shown in FIG. 5B. The fuel field seal 290 is preferably compatible with the materials of the fuel electrode 130 and the interconnect 200B.

Accordingly, the fuel field seal 290 may be formed of a glass or glass-ceramic material having a dilatometric softening point ranging from about 600° C. to about 750° C., such as from about 640° C. to about 730° C., and an operating temperature ranging from about 750° C. to about 850° C., such as from about 775° C. to about 825° C. For example, the fuel field seal 290 may be formed of amorphous glass materials such as G018-354 or G018-391 available from Schott AG, Germany, or GL1835P available from MO SCI LLP, USA.

The ring seals 294 are also subject to no net lateral pressurization. However, the ring seals 294 may be subjected to a voltage during stack operation. In addition, the ring seals 294 may have lower flowability than the fuel field seals 290. Accordingly, the ring seals 294 may be formed of formed of a combination of (i) an amorphous glass material, such as G018-354 or G018-391, available from Schott AG, Germany, or GL1835P available from MO SCI LLP, USA; (ii) a crystallizing glass-ceramic material such as NYG353, available from Nihon Yamamura Glass Co., Ltd, Japan; and (iii) a compliant vermiculite gasket material, such as Thermiculite® 866 or 870 available from Flexitallic US LLC, USA.

Thermiculite® is a high temperature sealing material designed for SOFC applications. It is based upon the mineral vermiculite and contains no organic binder or any other organic component. Vermiculite is a natural sheet silicate mineral formed by hydro-thermal modification of biotite and phlogopite mica. It retains all the thermal and chemical durability of mica and remains electrically insulating. Like mica, vermiculite occurs as plate morphology particles, consisting of thousands of individual platelets and having a thickness in a nanometer range, which are stacked together. These particles can be exfoliated to produce a dispersion of individual platelets which are separated from each other. These platelets are highly flexible and conform to the surfaces of other particles to bind them together. This binding action allows a sheet material to be manufactured without any organic binding agents being present. As such, Thermiculite® consists just of the chemically exfoliated vermiculite and a second filler material. The second filler material is talc, also known as steatite or soapstone. The second filler material is relatively soft. As such, the combination of the chemically exfoliated vermiculite with steatite results in a material that retains all the chemical and thermal durability usually associated with mica and meanwhile is very soft and conformable. The softness of the material and the platelet alignment allows the material to be compressible under very low load to produce a compacted material that offers a very tortuous and passage stopping path to any gas that is permeating through the material in the plane of the sheet or perpendicular to that plane. Accordingly, the material has sealing characteristics.

The pressurized air is applied inside of the pressure seal 292 and atmospheric pressure is applied outside of the pressure seal 292. As such, the pressure seal 292 is subjected to a net pressure differential. The pressure seal 292 does not contact a fuel such as a hydrocarbon fuel, does not require high flowability, and does not contact the cell 100. The pressure seal 292 is also subjected to a voltage during stack operation.

Accordingly, the pressure seal 292 may be formed of a material having a higher compression resistance than the ring seals 294 and/or a higher stiffness than the fuel field seal 290. For example, the pressure seal 292 may be formed of a combination of (i) a crystallizing glass-ceramic material, such as NYG353, available from Nihon Yamamura Glass Co., Ltd, Japan; and (ii) a compliant vermiculite material, such as Thermiculite® 866 or 870 available from Flexitallic US LLC, USA. Optionally, the pressure seal may also include a high temperature amorphous glass material having a dilatometric softening point above 800° C., such as G018-281, available from Schott AG, Germany, which has a dilatometric softening point above 850° C.

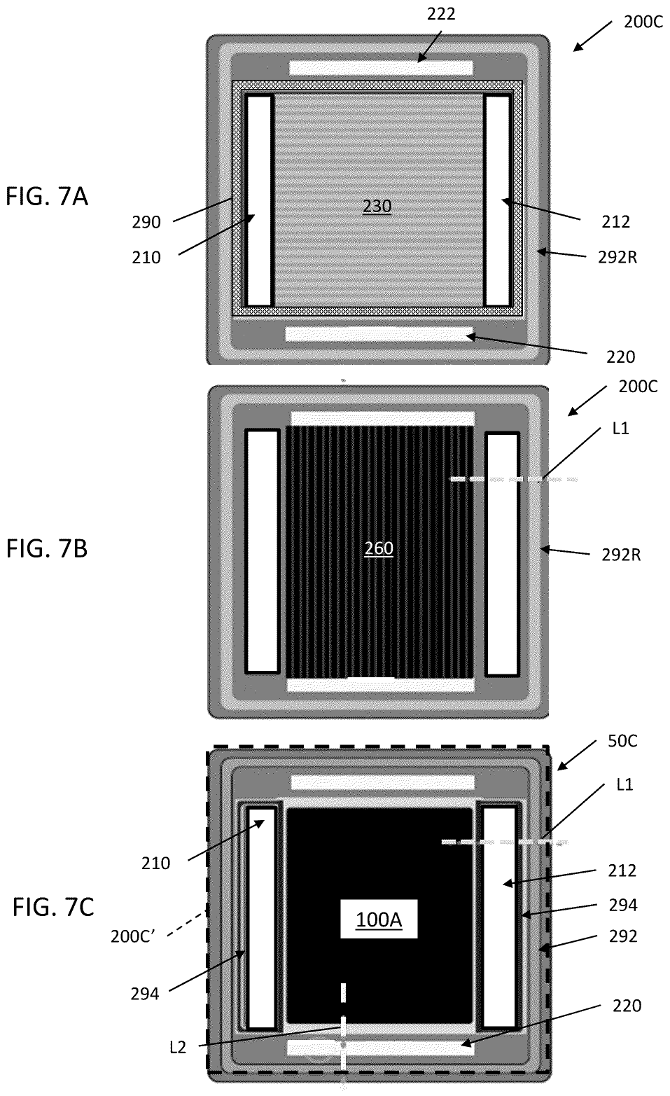

FIG. 7A is a plan view of the fuel side of an interconnect 200C, according to various embodiments of the present disclosure, FIG. 7B is a plan view of the air side of the interconnect 200C, and FIG. 7C is a partially transparent plan view of a stack cell unit 50C including an electrolyte supported electrochemical cell 100A located on the air side of the interconnect 200C. The interconnect 200C may be similar to the interconnect 200B. As such, only the differences therebetween will be discussed in detail. The interconnect 200C is configured to operate in a stack with electrolyte supported cells 100A. In one embodiment, the interconnect 200C may be formed from the Cr—Fe alloy described above.

Referring to FIGS. 7A and 7B, the interconnect 200C may include fuel holes 210, 212 and air holes 220, 222. The fuel holes 210, 212 may be located adjacent to opposing first and second edges of the interconnect 200C. The air holes 220, 222 may be located adjacent to opposing third and fourth edges of the interconnect 200C. The fuel side of the interconnect 200C may include a fuel field 230 located between the fuel holes 210, 212. The air side of the interconnect 200C may include an air field 260 located between the air holes 220, 222.

A rectangular fuel field seal 290 may be located on the interconnect 200C, surrounding the fuel field 230 and the fuel holes 210, 212. The fuel field seal 290 may extend between opposing sides of the fuel field 230 and the air holes 220, 222.

Referring to FIG. 7C, an electrolyte-supported cell 100A may be located on the fuel side of the interconnect 200C. Ring seals 294 may be located around the fuel holes 210, 212 and may overlap with the fuel electrode 130 of the cell 100A. A pressure seal 292 may be located on the pressure seal region 292R, and a second interconnect 200C′ may be located over the cell 100A.

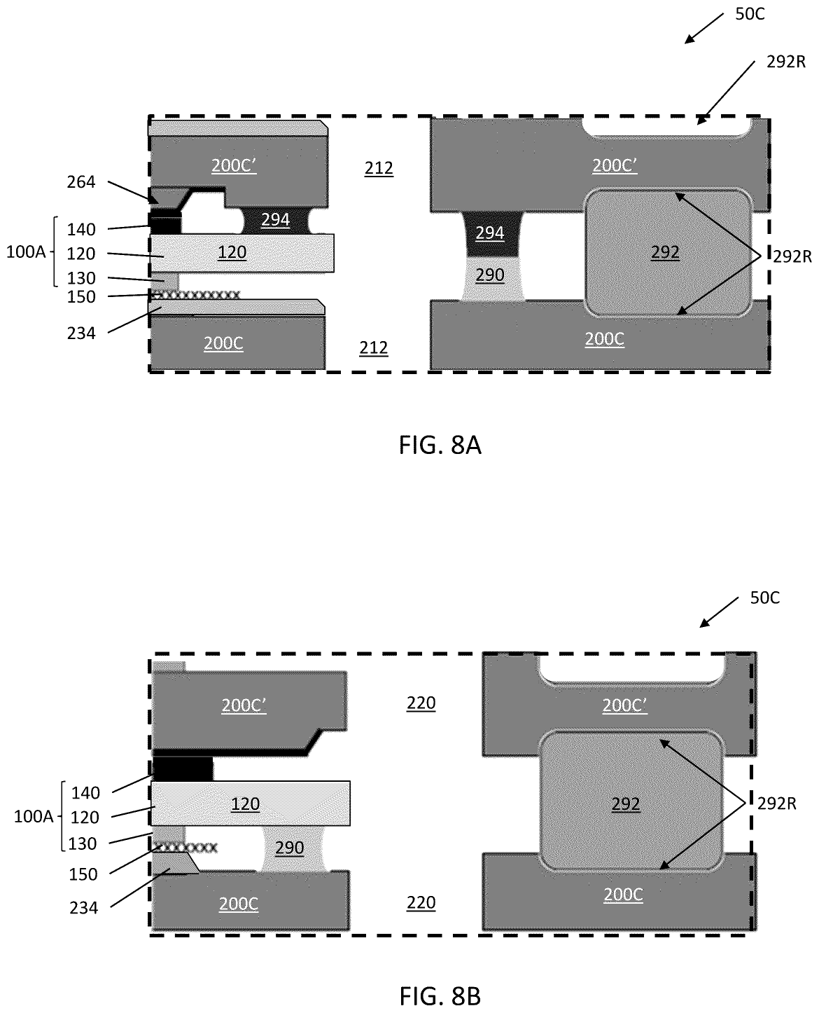

FIG. 8A is a cross-sectional view taken along line L1 of FIG. 7C, and FIG. 8B is a cross-sectional view taken along line L2 of FIG. 7C. The location of line L1 is also shown in FIG. 7B for reference. Referring to FIGS. 8A and 8B, a portion of the ring seal 294 that is located inward of the fuel holes 212 may contact the second interconnect 200C′ and the electrolyte 120 of the cell 100A, and a portion of the ring seal 294 that is located outward of the fuel hole 212 may contact the second interconnect 200C′ and overlap with a corresponding portion of the fuel field seal 290.

The pressure seal 292 may be located in recessed pressure seal regions 292R formed in opposing surfaces of the interconnects 200C, 200C′. As such, the pressure seal 292 prevents pressurized air from leaking out of a cell stack between the interconnects 200C, 200C′.

A portion of the fuel field seal 290 located inward of the air holes 220 may contact the electrolyte 120 and the fuel side of the interconnect 200C. Another portion of the fuel field seal 290 located outward of the air holes 222 may contact the ring seal 294 and the fuel side of the interconnect 200C. As such, the fuel field seal 290 prevents mixing of fuel and air.

The air side ribs 264 of the second interconnect 200C′ may contact portions of the air electrode 140 of the cell 100A. The compliant contact layer 150 may be located between the fuel side ribs 234 of the interconnect 200C and the fuel electrode 130 of the cell 100A.

In embodiments that include electrolyte-supported cells 100A, the fuel field seals 290 may include a high temperature amorphous glass material, such as G018-281, or a mixture of 90 to 99% of G018-281 and 1 to 10 wt. % G018-354 glass.

In the electrolyte-supported cell 100A embodiments, the ring seals 294 may be formed of formed of a combination of (i) a high temperature amorphous glass material, such as G018-281, or a mixture of 90 to 99% of G018-281 and 1 to 10 wt. % G018-354 glass; (ii) a crystallizing glass-ceramic material such as G018-394, available from Schott AG, Germany; and (iii) a compliant vermiculite gasket material, such as Thermiculite® 866 or 870 available from Flexitallic US LLC, USA.

In the electrolyte-supported cell 100A embodiments, the pressure seal 292 may comprise a combination of (i) a crystallizing glass-ceramic material, such as G018-394, available from Schott AG, Germany, and (ii) a compliant vermiculite gasket material, such as Thermiculite® 866 or 870 available from Flexitallic US LLC, USA.

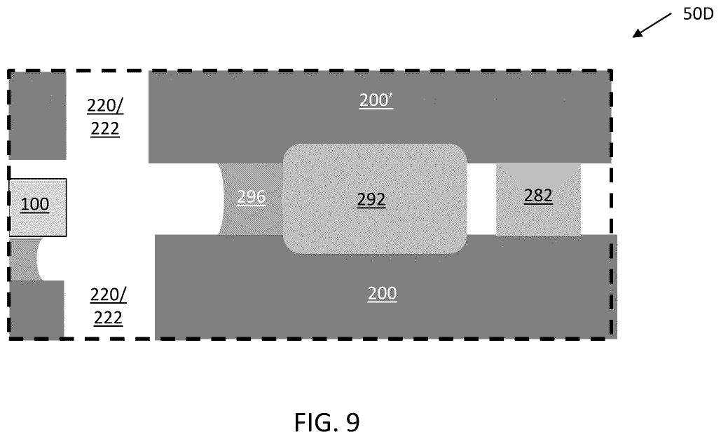

FIG. 9 is a cross-sectional view of a portion of a cell unit 50D including alternative sealing features, according to various embodiments of the present disclosure.

Referring to FIG. 9, the cell unit 50D may include a first interconnect 200, a second interconnect 200′, an electrochemical cell 100 located therebetween, and a pressure seal 292. The interconnects 200, 200′ may be similar to any of the interconnects 200A-200C.

An optional internal pressure seal 296 may be located laterally inward of the pressure seal 292. The internal pressure seal 296 may be formed of a glass or glass-ceramic material, such as Schott G018-351 or G018-354. In some embodiments, the internal pressure seal 296 may be used in conjunction with the vermiculite containing pressure seal 292 to improve sealing. The pressure seal 292 may be configured to prevent failure of the internal pressure seal 296 by preventing lateral outward flow of the internal pressure seal 296 at high temperatures.

In other embodiments, an optional support frame 282 may be located laterally outward of the pressure seal 292. The support frame 282 may be formed of a dielectric material. For example, the support frame 282 may be formed by printing a dielectric material layer on the fuel side of the first interconnect 200 or the air side of the second interconnect 200′. The dielectric material may comprise any suitable material which matches the coefficient of thermal expansion of the interconnect 200 material. For example, the dielectric material may comprise ceria if the interconnect 200 comprises a stainless steel material. Alternatively, the dielectric material may comprise a glass-ceramic material comprising a glassy matrix containing zirconium silicate and magnesium aluminosilicate crystals if the interconnect 200 comprises a Cr—Fe alloy. The glass-ceramic material comprising a glassy matrix containing zirconium silicate and magnesium aluminosilicate crystals is described in U.S. Pat. No. 10,763,533 B1 issued on Sep. 1, 2020, and incorporated herein by reference in its entirety. The support frame 282 may be configured to prevent excess cell compression by maintaining a minimum distance between the interconnects 200, 200′.

In various embodiments, the fuel field seal 290 is located on the fuel side of the first interconnect (200, 200A, 200B, or 200C) and configured to keep the fuel from flowing into the air holes 220 and 222 in the first interconnect. The fuel field seal 290 bonds the fuel side of the first interconnect to the electrochemical cell (100 or 100A).

The ring seals 294 are located on the air side of the second interconnect (200′, 200A′, 200B′, or 200C′) and laterally surrounding the fuel holes 214 and 216. The ring seals bond the air side of the second interconnect to the electrochemical cell.

The pressure seal extends 292 from the fuel side of the first interconnect to the air side of the second interconnect, and laterally surrounds the electrochemical cell (100 or 100A), the fuel field seal 290, and the ring seals 294. The pressure seal 292 bonds the fuel side of the first interconnect to the air side of the second interconnect, and hermetically seals the cell unit (50A, 50B, 50C or 50D) to permit the cell unit to operate above atmospheric pressure (e.g., at 15 psig or greater).

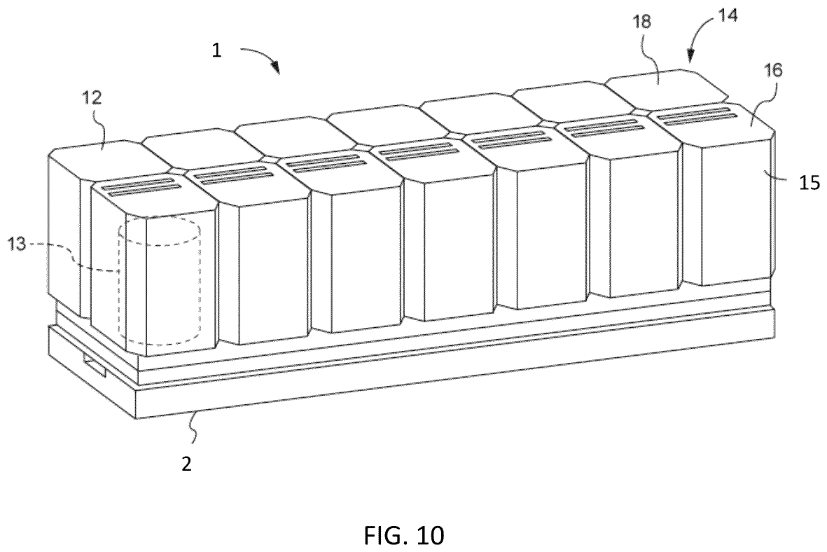

FIG. 10 illustrates a modular electrolyzer system 1. The system includes a plurality of module cabinets 14 (e.g., housing containers with doors 15). The module cabinets 14 include electrolyzer generator modules 12, optional steam processing module 16, and one or more power conditioning modules 18 (i.e., electrical input modules including an AC/DC inverter). For example, the system 1 may include any desired number of modules, such as 2-30 generator modules, 3-12 generator modules, 6-12 generator modules, or other large site configuration of generator modules. Each generator module 12 is configured to house a hotbox 13. Each hotbox 13 contains one or more stacks or columns 10 of electrolyzer cells described above. The module cabinets 14 are located on a support 2, such as a concrete pad or a metal skid. The system 1 may include one or more rows of module cabinets 14. For example, the system 1 may include two rows of cabinets 14 (e.g., generator module 12 housings) arranged back to back.

According to various embodiments, the electrolyzer system 1 comprises a non-hermetic cabinet 14 (e.g., a housing of a generator module 12 with a door 15); and a non-hermetic hotbox 13 housing the electrochemical cell stack 10 and located in the cabinet 14. The electrolyzer system 1 lacks a pressure vessel. In other words, there is no pressure vessel in the hotbox 13 or in the cabinet 14, and the hotbox 13 and the cabinet 14 are not-hermitic and are not pressure vessels.

According to various embodiments, a method of operating a solid oxide electrolyzer cell stack 10A or 10B of various embodiments includes providing steam into a fuel internal riser 214 extending through the solid oxide electrolyzer cell stack at a pressure of at least 15 psig, providing air into air internal riser 224 extending through the solid oxide electrolyzer cell stack at a pressure of at least 15 psig, and electrolyzing the steam in the solid oxide electrolyzer cell stack to generate a hydrogen containing product stream at a pressure of at least 15 psig.

In one embodiment, the solid oxide electrolyzer cell stack 10A or 10B is hermetically sealed by pressure seals 292, and the solid oxide electrolyzer cell stack is not located in an external pressure vessel. In one embodiment, the method further comprises providing carbon dioxide into the fuel internal riser 214, wherein the hydrogen containing product stream comprises methane.

Fuel cell and electrolyzer cell systems of the embodiments of the present disclosure are designed to reduce greenhouse gas emissions and have a positive impact on the climate.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An electrochemical cell stack comprising cell units, each cell unit comprising:
a first interconnect comprising fuel holes, air holes, and a fuel field that extends between the fuel holes on a fuel side of the first interconnect;
a second interconnect comprising fuel holes, air holes, and air field that extends between the air holes on an air side of the second interconnect;
an electrochemical cell comprising a fuel electrode that electrically contacts portions of the fuel field, an air electrode that electrically contacts portions of the air field and a solid oxide electrolyte located between the fuel electrode and the air electrode;
a fuel field seal located on the fuel side of the first interconnect and configured to keep the fuel from flowing into the air holes in the first interconnect;
ring seals located on the air side of the second interconnect and laterally surrounding the fuel holes; and
a pressure seal extending from the fuel side of the first interconnect to the air side of the second interconnect, and laterally surrounding the electrochemical cell, the fuel field seal, and the ring seals.

2. The electrochemical cell stack of claim 1, wherein for each of the cell units:
the fuel field seal bonds the fuel side of the first interconnect to the electrochemical cell;
the ring seals bond the air side of the second interconnect to the electrochemical cell; and
the pressure seal bonds the fuel side of the first interconnect to the air side of the second interconnect, and hermetically seals the cell unit to permit the cell unit to operate above atmospheric pressure.

3. The electrochemical cell stack of claim 1, further comprising a stack manifold fluidly connected to the cell units and configured to provide pressurized fuel and air to the cell units through the fuel holes and the air holes, respectively, at a pressure of at least 15 psig.

4. The electrochemical cell stack of claim 3, wherein for each of the cell units:
the pressure seal is located in a first recess in the fuel side of the first interconnect and in a second recess in the air side of the second interconnect; and
the pressure seal is configured to prevent the pressurized air from exiting the air field in a lateral direction.

5. The electrochemical cell stack of claim 1, wherein for each of the cell units:
the pressure seal has a higher stiffness than the fuel field seal and a higher compression resistance than the ring seals;
the fuel field seal comprises an amorphous glass material;
the ring seals comprise a glass or glass-ceramic material; and
the pressure seal comprises a compliant vermiculite gasket material.

6. The electrochemical cell stack of claim 5, wherein each of the cell units further comprises an internal pressure seal located laterally inward of the pressure seal and consisting essentially of a glass or a glass-ceramic material.

7. The electrochemical cell stack of claim 1, wherein each of the cell units further comprises an insulating support frame located laterally outward of the pressure seal between the first and second interconnects.

8. The electrochemical cell stack of claim 1, wherein for each of the cell units:
the first interconnect further comprises first and second support walls and a recess between the first and the second support walls;
the first and second support walls are located on opposing sides of the fuel field, between the fuel field and the air holes;
the electrochemical cell comprises a fuel electrode supported electrochemical cell;
the fuel electrode supported electrochemical cell is located in the recess in the first interconnect; and
the fuel field seal comprises linear segments located between the first and second support walls.

9. The electrochemical cell stack of claim 1, wherein for each of the cell units:
the electrochemical cell comprises an electrolyte supported electrochemical cell;
portions of the ring seals and the fuel field seal directly contact the electrolyte; and
portions of the fuel field seal vertically overlap with portions of the ring seals.

10. The electrochemical cell stack of claim 1, wherein for each of the cell units:
the fuel field comprises fuel channels that extend in a first direction; and
the air field comprises air channels that extend in a second direction perpendicular to the first direction.

11. The electrochemical cell stack of claim 1, wherein for each of the cell units:
the fuel field comprises fuel channels that extend in a first direction; and
the air field comprises air channels that extend in the first direction parallel to the first direction.

12. The electrochemical cell stack of claim 2, wherein for each of the cell units the electrochemical cell is a solid oxide fuel cell.

13. The electrochemical cell stack of claim 2, wherein for each of the cell units the electrochemical cell is a solid oxide electrolyzer cell.

14. An electrolyzer system, comprising:
a cabinet; and
a non-hermetic hotbox housing the electrochemical cell stack of claim 13, and located in the cabinet, wherein the electrolyzer system lacks a pressure vessel.

15. A method of operating the electrochemical cell stack of claim 13, comprising:
providing steam into the fuel holes at a pressure of at least 15 psig; and
electrolyzing the steam to generate a hydrogen product stream at a pressure of at least 15 psig.

16. A method of operating the electrochemical cell stack of claim 13, comprising:
providing steam and carbon dioxide into the fuel holes at a pressure of at least 15 psig; and
electrolyzing the steam and carbon dioxide to generate a methane product stream at a pressure of at least 15 psig.

17. A method of operating a solid oxide electrolyzer cell stack, comprising:
providing steam into a fuel internal riser extending through the solid oxide electrolyzer cell stack at a pressure of at least 15 psig; and
electrolyzing the steam in the solid oxide electrolyzer cell stack to generate a hydrogen containing product stream at a pressure of at least 15 psig.

18. The method of claim 17, further comprising providing air into an air internal riser extending through the solid oxide electrolyzer cell stack at a pressure of at least 15 psig, wherein the solid oxide electrolyzer cell stack is hermetically sealed by pressure seals, and the solid oxide electrolyzer cell stack is not located in an external pressure vessel.

19. The method of claim 17, further comprising providing carbon dioxide into the fuel internal riser, wherein the hydrogen containing product stream comprises methane.

20. A method of forming of an electrochemical cell stack, comprising:
forming a first cell unit by disposing a pressure seal, ring seals, and an electrochemical cell between two vertically stacked interconnects, such that the pressure seal laterally surrounds the ring seals and the electrochemical cell, the ring seals support the weight of the second interconnect, and the electrochemical cells are located between respective air channels and fuel channels of the two vertically stack interconnects;
forming additional cell units on the first cell unit to form a stack by disposing, for each additional cell unit, an additional pressure seal, ring seals, an electrochemical cell, and an additional interconnect;
sintering the stack to compress the ring seals, such that the interconnects are supported by the pressure seals;
applying a compressive load to the stack to compress the pressure seals, such that the interconnects apply a first load to the electrochemical cells; and
supplying pressurized air to the air channels and a pressurized fuel to the fuel channels, such that the interconnects apply a second load to the electrochemical cells that is less than the first load.
